(19) United States
(12) Patent Application Publication
(10) Pub. No.: US 2025/0088914 A1
(43) Pub. Date: Mar. 13, 2025

(54) CONTEXT ACQUISITION FOR SEAMLESS ROAMING

(71) Applicant: QUALCOMM Incorporated, San Diego, CA (US)

(72) Inventors: Sai Yiu Duncan HO, San Diego, CA (US); Abhishek Pramod PATIL, San Diego, CA (US); George CHERIAN, San Diego, CA (US); Abdel Karim AJAMI, San Diego, CA (US); Yanjun SUN, San Diego, CA (US); Gaurang NAIK, San Diego, CA (US); Alfred ASTERJADHI, San Diego, CA (US)

(21) Appl. No.: 18/464,193

(22) Filed: Sep. 8, 2023

(51) Int. Cl. H04W 36/00; H04W 36/32

(52) U.S. Cl. CPC H04W 36/0033; H04W 36/32

(57) ABSTRACT

This disclosure provides methods, components, devices, and systems that support context acquisition for seamless roaming. Some aspects more specifically relate to segmenting a packet number (PN) space into subsets that are dynamically assigned to access points (APs) associated with a station (STA). In some implementations, a first wireless device (such as a STA) may communicate with a second wireless device (such as a serving AP) using a first subset of user data context parameters (such as a group or segment of PNs) that correspond to a first index assigned to the second wireless device. If, for example, the first wireless device decides to roam to a third wireless device (such as a target AP), the first wireless device may transmit one or more packets to the third wireless device using a second subset of the user data context parameters assigned to the third wireless device.

### TECHNICAL FIELD

This disclosure relates to wireless communication and, more specifically, to context acquisition for seamless roaming.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a STA may roam from one AP (such as a serving AP) to another AP (such as a target AP) based on various conditions, including (but not limited to) a location of the STA or a signal strength of the target AP. In some implementations, however, the STA may be unable to exchange data with the target AP until the STA obtains context information (such as a set of encryption keys) from the target AP, which may increase the latency associated with roaming operations.

### SUMMARY

The systems, methods, and devices of this disclosure each have several innovative aspects, no single one of which is solely responsible for the desirable attributes disclosed herein.

A first wireless device is described. The first wireless device includes a processing system of processor circuitry and memory circuitry that stores code, where the processing system is configured to cause the first wireless device to: communicate with a second wireless device via a first set of communication links between the first wireless device and the second wireless device using a first subset of user data context parameters corresponding to a first index assigned to the second wireless device; roam from the second wireless device to a third wireless device based on a status of the first set of communication links and based on a status of a second set of communication links between the first wireless device and the third wireless device, where the roaming comprises transmitting user data to the third wireless device via the second set of communication links using a second subset of the user data context parameters corresponding to a second index assigned to the third wireless device; and communicate with the third wireless device via the second set of communication links based on using the second subset of the user data context parameters to roam from the second wireless device to the third wireless device.

A third wireless device is described. The third wireless device includes a processing system of processor circuitry and memory circuitry that stores code, where the processing system is configured to cause the third wireless device to: obtain an indication of a second index assigned to the third wireless device, the second index corresponding to a second subset of user data context parameters that are usable for communications with a first wireless device; receive, via a second set of communication links between the third wireless device and the first wireless device that is roaming from a second wireless device to the third wireless device, user data that indicates the second subset of the user data context parameters corresponding to the second index assigned to the third wireless device, where a first subset of the user data context parameters corresponds to a first index assigned to the second wireless device from which the first wireless device is roaming; and communicate with the first wireless device via the second set of communication links using the second subset of the user data context parameters corresponding to the second index assigned to the third wireless device based on receiving the user data from the first wireless device roaming from the second wireless device to the third wireless device.

A method for wireless communication by a first wireless device is described. The method includes: communicating with a second wireless device via a first set of communication links between the first wireless device and the second wireless device using a first subset of user data context parameters corresponding to a first index assigned to the second wireless device; roaming from the second wireless device to a third wireless device based on a status of the first set of communication links and based on a status of a second set of communication links between the first wireless device and the third wireless device, where the roaming comprises transmitting user data to the third wireless device via the second set of communication links using a second subset of the user data context parameters corresponding to a second index assigned to the third wireless device; and communicating with the third wireless device via the second set of communication links based on using the second subset of the user data context parameters to roam from the second wireless device to the third wireless device.

A method for wireless communications by a third wireless device is described. The method includes: obtaining an indication of a second index assigned to the third wireless device, the second index corresponding to a second subset of user data context parameters that are usable for communications with a first wireless device; receiving, via a second set of communication links between the third wireless device and the first wireless device roaming from a second wireless device to the third wireless device, user data that indicates the second subset of the user data context parameters corresponding to the second index assigned to the third wireless device, where a first subset of the user data context parameters corresponds to a first index assigned to the second wireless device from which the first wireless device is roaming; and communicating with the first wireless device via the second set of communication links using the second subset of the user data context parameters corresponding to the second index assigned to the third wireless device based on receiving the user data from the first wireless device roaming from the second wireless device to the third wireless device.

In some implementations, the first wireless device may transmit or receive, via the second set of communication links, a message containing a packet number (PN) field associated with the second index assigned to the third wireless device, where a first quantity of bits in the PN field indicate the second index and a second quantity of bits in the PN field indicate a PN value within a PN segment associated with the second index.

In some other implementations, the first wireless device may transmit or receive, via the second set of communication links, a frame containing a PN value associated with the second subset of the user data context parameters and a separate field indicating the second index assigned to the third wireless device.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a signaling diagram that supports context acquisition for seamless roaming.

FIG. 6 shows an example of a process flow that supports context acquisition for seamless roaming.

FIG. 7 shows a block diagram of an example wireless device that supports context acquisition for seamless roaming.

FIG. 8 shows a block diagram of an example wireless device that supports context acquisition for seamless roaming.

FIG. 9 shows a flowchart illustrating an example process performable by or at a first wireless device that supports context acquisition for seamless roaming.

FIG. 10 shows a flowchart illustrating an example process performable by or at a third wireless device that supports context acquisition for seamless roaming.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others.

The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

A WLAN may include one or more access points (APs) and non-AP stations (STAs) that communicate with each other via specific communication links (such as channels within a given frequency band). In some WLANs that support multi-link operations (MLO), a non-AP STA may be affiliated with a non-AP multi-link device (MLD) that operates on multiple communication links. For example, a first STA of the non-AP MLD may operate on a first communication link (such as a 2.4 gigahertz (GHz) channel), while a second STA of the non-AP MLD may operate on a second communication link (such as a 6 GHz channel). Likewise, an AP may be affiliated with (for example, controlled or managed by) one or more AP MLDs that operate on more than one communication link. As used herein, the term “STA” may refer to any type of wireless STA, such as a non-AP STA, a non-MLD STA, a non-MLD non-AP STA, or the like. Similarly, the term “AP” may refer to any type of wireless AP, such as an AP MLD or a non-MLD AP, among other examples.

In some implementations, a STA (such as a non-AP MLD or a non-MLD non-AP STA) may roam from a first AP (such as a serving AP) to a second AP (such as a target AP) based on various conditions, including (but not limited to) a location of the STA, a signal strength of the first AP, a signal strength of the second AP, and so on. To begin exchanging user data with the second AP, however, the STA may have to wait for the first AP to provide the second AP with various user data context parameters, such as an encryption key, a packet number (PN), a sequence number (SN), a block acknowledgement (BA), and a set of encryption keys for the STA, which can introduce latency and signaling overhead.

Various aspects of the present disclosure relate generally to context acquisition for seamless roaming. Some aspects more specifically relate to segmenting a PN space into subsets that are dynamically assigned to APs associated with a given STA. In some implementations, a first wireless device (such as a non-AP MLD or a non-MLD non-AP STA) may communicate with a second wireless device (such as a serving AP of the first wireless device) using a first subset of user data context parameters (such as a group or segment of PNs) that correspond to a first index assigned to the second wireless device. If, for example, the first wireless device decides to roam to a third wireless device (such as a target or neighboring AP), the first wireless device may transmit one or more packets to the third wireless device using a second subset of the user data context parameters assigned to the third wireless device, thereby enabling the first wireless device to begin exchanging user data with the third wireless device without having to wait for the second wireless device to provide user data context information to the third wireless device.

Particular aspects of the subject matter described in this disclosure can be implemented to realize one or more of the following potential advantages. In some implementations, by assigning specific subsets or segments of user data context parameters (such as PNs, SNs, BAs, and the like) to a group of candidate APs, the described techniques may enable the STA to quickly roam to (and connect with) a target AP by using a subset of user data context parameters associated with (for example, assigned to) the target AP. Furthermore, the described techniques can be used for seamless roaming, whereby the STA transitions from a serving AP to a target AP without performing a reassociation frame exchange with the target AP.

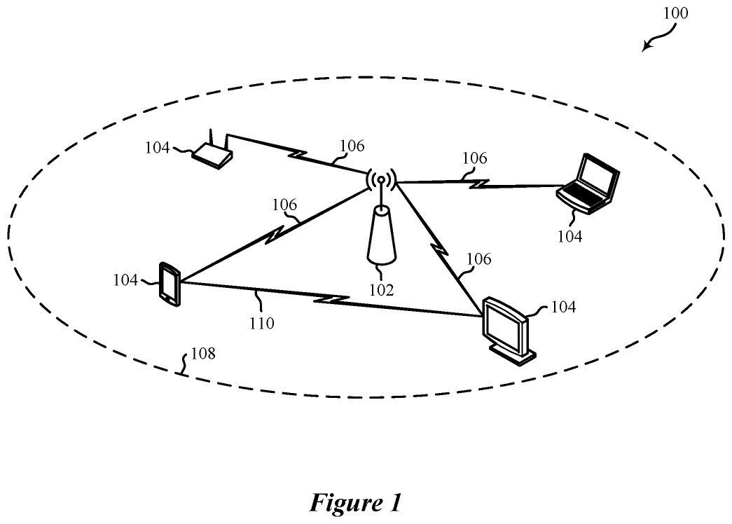

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless devices within the wireless communication network 100 or to enable such devices to connect to a cellular network's core, such as to access the network management capabilities and functionality offered by the cellular network core.

The wireless communication network 100 may include numerous wireless devices including at least one wireless AP 102 and any number of wireless STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHZ, and 60 GHz bands. Some implementations of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHZ), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

In some implementations, a first wireless device (such as a STA 104) may communicate with a second wireless device (such as a serving AP 102) via a first set of communication links 106 using a first subset of multiple user data context parameters corresponding to a first index assigned to the second wireless device. The first wireless device may roam from the second wireless device to a third wireless device (such as a target AP 102) based on a status of the first set of communication links 106 and a status of a second set of communication links 106 between the first wireless device and the third wireless device. To roam (for example, transition) from the second wireless device to the third wireless device, the first wireless device may transmit user data to the third wireless device (via the second set of communication links 106) using a second subset of the multiple user data context parameters corresponding to a second index assigned to the third wireless device.

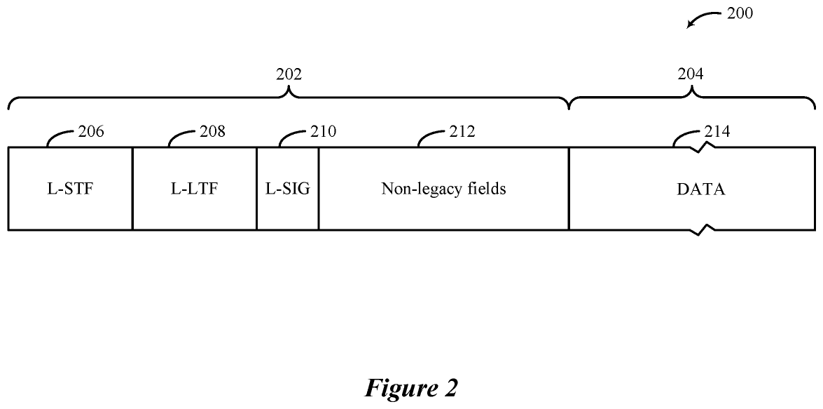

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

In some implementations, a first wireless device (such as a STA 104) may communicate with a second wireless device (such as a serving AP 102) via a first set of communication links 106 using a first subset of multiple user data context parameters corresponding to a first index assigned to the second wireless device. The first wireless device may roam from the second wireless device to a third wireless device (such as a target AP 102) based on a status of the first set of communication links 106 and a status of a second set of communication links 106 between the first wireless device and the third wireless device. To roam (for example, transition) from the second wireless device to the third wireless device, the first wireless device may transmit user data (such as a PDU 200) to the third wireless device (via the second set of communication links 106) using a second subset of the multiple user data context parameters corresponding to a second index assigned to the third wireless device.

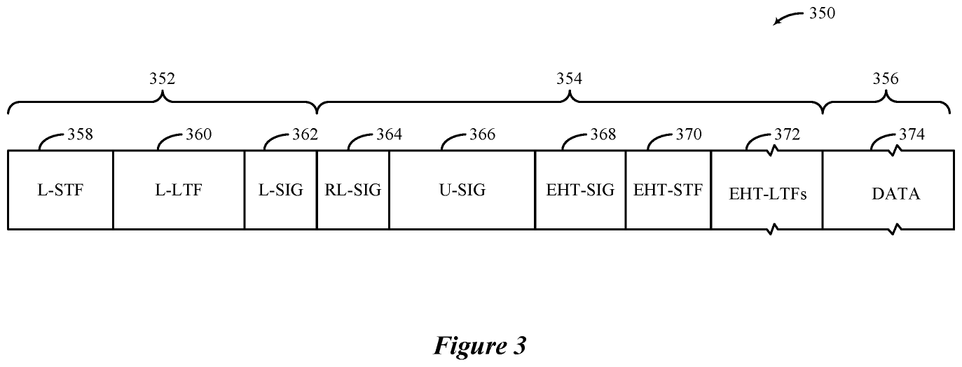

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field (referred to herein as “U-SIG 366”) and an EHT signal field (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as the AP 102 or the STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field (referred to herein as “EHT-STF 370,” although it may be structured as, and carry version-dependent information for, other wireless communication protocol versions beyond EHT) and one or more additional long training fields (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

In some implementations, a first wireless device (such as a STA 104) may communicate with a second wireless device (such as a serving AP 102) via a first set of communication links 106 using a first subset of multiple user data context parameters corresponding to a first index assigned to the second wireless device. The first wireless device may roam from the second wireless device to a third wireless device (such as a target AP 102) based on a status of the first set of communication links 106 and a status of a second set of communication links 106 between the first wireless device and the third wireless device. To roam (for example, transition) from the second wireless device to the third wireless device, the first wireless device may transmit user data (such as a PPDU 350) to the third wireless device (via the second set of communication links 106) using a second subset of the multiple user data context parameters corresponding to a second index assigned to the third wireless device.

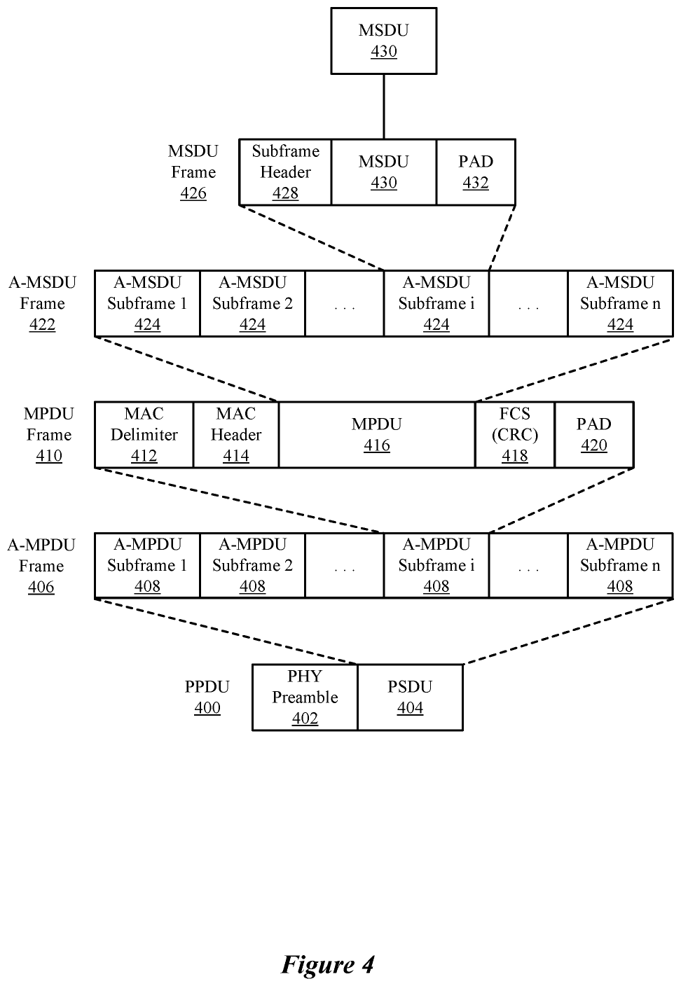

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 406 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field may include a cyclic redundancy check (CRC)) and padding bits 420. The MPDU 416 may carry one or more MAC service data units (MSDUs) 426. For example, the MPDU 416 may carry an aggregated MSDU (A-MSDU) 422 including multiple A-MSDU subframes 424. Each A-MSDU subframe 424 contains a corresponding MSDU 430 preceded by a subframe header 428 and in some implementations followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or BA of the PPDU that is to be transmitted by the receiving wireless device. The use of the duration field serves to reserve the wireless medium for the indicated duration, and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

Some wireless devices (including both APs and STAs such as, for example, AP 102 and STAs 104 described with reference to FIG. 1) are capable of multi-link operation (MLO). In some implementations, MLO supports establishing multiple different communication links (such as a first link on the 2.4 GHz band, a second link on the 5 GHz band, and the third link on the 6 GHz band) between the STA 104 and the AP 102 and exchanging packets on one or more communications links concurrently and dynamically. Each communication link may support one or more sets of channels or logical entities. In some implementations, each communication link associated with a given wireless device may be associated with a respective radio of the wireless device, which may include one or more transmit/receive (Tx/Rx) chains, include or be coupled with one or more physical antennas, or include signal processing components, among other components. An MLO-capable device may be referred to as an MLD. An MLD may include a single upper MAC layer, and can include, for example, three independent lower MAC layers and three associated independent PHY layers for respective links in the 2.4 GHz, 5 GHZ, and 6 GHz bands. This architecture may enable a single association process and security context. An AP MLD may include multiple APs each configured to communicate on a respective communication link with a respective one of multiple STAs 104 of a non-AP MLD (also referred to as a “STA MLD”). The STA MLD may communicate with the AP MLD over one or more of the multiple communication links at a given time. MLDs may independently contend for access on each of the communication links, which achieves latency reduction by enabling the MLD to transmit its packets on the first communication link that becomes available.

Another feature of MLO is Traffic Steering and QoS characterization, which achieves latency reduction and other QoS enhancements by mapping traffic flows having different latency or other requirements to different links. For example, traffic with low latency requirements can be mapped to wireless links operating in the 6 GHz band and more latency-tolerant flows can be mapped to wireless links operating in the 2.4 GHz or 5 GHz bands.

One type of MLO is alternating multi-link, in which a MLD may listen to two different high performance channels at the same time. When an MLD has traffic to send, it may use the first channel with an access opportunity (such as TXOP). While the MLD may only use one channel to receive or transmit at a time, having access opportunities in two different channels provides low latency when networks are congested.

Another type of MLO is multi-link aggregation (MLA), where traffic associated with a single STA 104 is simultaneously transmitted across multiple communication links in parallel to maximize the utilization of available resources to achieve higher throughput. This is akin to carrier aggregation in the cellular space. That is, during at least some duration of time, transmissions or portions of transmissions may occur over two or more links in parallel at the same time. In some implementations, the parallel wireless communication links may support synchronized transmissions. In some other examples, or during some other durations of time, transmissions over the links may be parallel, but not be synchronized or concurrent. In some implementations or durations of time, two or more of the links may be used for communications between the wireless devices in the same direction (such as all uplink or all downlink). In some other examples or durations of time, two or more of the links may be used for communications in different directions. For example, one or more links may support uplink communications and one or more links may support downlink communications. In such examples, at least one of the wireless devices operates in a full duplex mode. Generally, full duplex operation enables bi-directional communications where at least one of the wireless devices may transmit and receive at the same time.

MLA may be implemented in a number of ways. In some implementations, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless device, among other factors or considerations).

To support MLO techniques, an AP MLD and a STA MLD may exchange supported MLO capability information (such as supported aggregation type or supported frequency bands, among other information). In some implementations, the exchange of information may occur via a beacon signal, a probe request or probe response, an association request or an association response frame, a dedicated action frame, or an operating mode indicator (OMI), among other examples. In some implementations, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless device in terms of power consumption. Another benefit of MLO is the increased multiplexing opportunities in the case of a single BSS. For example, multi-link aggregation may increase the number of users per multiplexed transmission served by the multi-link AP MLD.

In some implementations, a first wireless device (such as a STA 104) may communicate with a second wireless device (such as a serving AP 102) via a first set of communication links 106 using a first subset of multiple user data context parameters corresponding to a first index assigned to the second wireless device. The first wireless device may roam from the second wireless device to a third wireless device (such as a target AP 102) based on a status of the first set of communication links 106 and a status of a second set of communication links 106 between the first wireless device and the third wireless device. To roam (for example, transition) from the second wireless device to the third wireless device, the first wireless device may transmit user data (such as a PPDU 400) to the third wireless device (via the second set of communication links 106) using a second subset of the multiple user data context parameters corresponding to a second index assigned to the third wireless device.

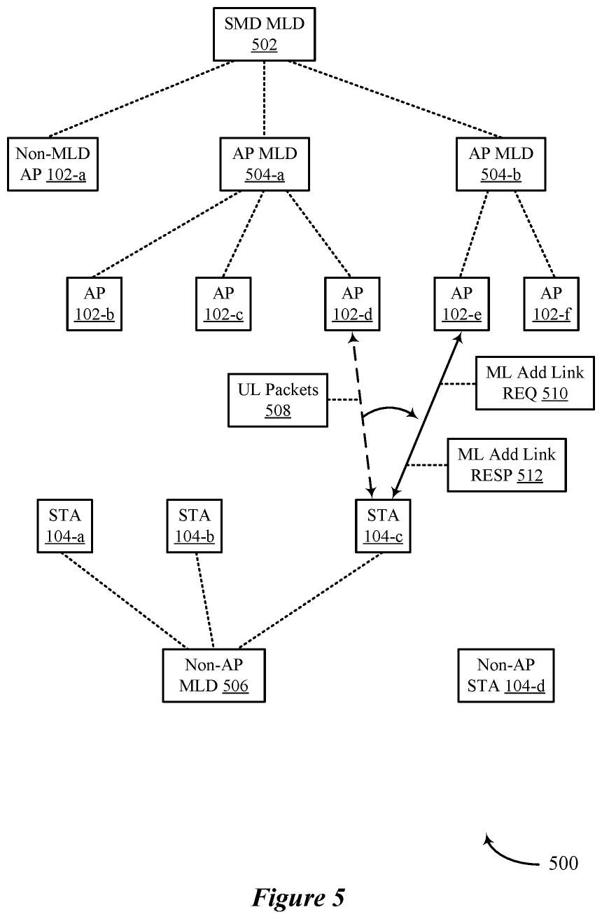

FIG. 5 shows an example of a signaling diagram 500 that supports context acquisition for seamless roaming. The signaling diagram 500 may implement one or more aspects of the wireless communication network 100. For example, the signaling diagram 500 includes an AP 102-a (such as a non-MLD AP), and AP 102-b (such as an MLD AP), an AP 102-c, an AP 102-d, an AP 102-e, and an AP 102-f, which may be examples of aspects of an AP 102, as shown and described with reference to FIG. 1.

Likewise, the signaling diagram 500 includes a STA 104-a (such as a non-AP MLD STA), a STA 104-b, a STA 104-c, and a STA 104-d (such as a non-MLD non-AP STA), which may be examples of a STA 104, as shown and described with reference to FIG. 1.

In some WLANs (such as the wireless communication network 100), when the signal strength of a serving AP (such as the AP 102-d) is weakening, a STA (such as the STA 104-c) may roam to a target AP (such as the AP 102-e) with a better signal quality without waiting for buffered/in-flight DL packets to arrive from the serving AP. Roaming may be useful for upper layer applications that are unaffected by packet loss during roaming, upper layer applications that can handle/process packets delivered out-of-order (between the serving and target APs) during roaming, etc. Roaming can also be used for periodic extended reality (XR) traffic, which may have a data burst arrival every 16.66 ms. Following a traffic burst, the STA may not expect more traffic until the next burst, so the STA can utilize this gap to roam to a better AP without data interruptions.

As used herein, the term “AP” encompasses both non-MLD APs (for example, APs that operate on a single communication link) and AP MLDs 504 that operate on more than one communication link. Likewise, the term “STA” encompasses both non-MLD non-AP STAs (such as STAs that operate on a single communication link) and non-AP MLD that operate on more than one communication link. Thus, in the following description of the signaling diagram 500, when referring to communications between a STA and an AP, the “STA” may be a non-MLD non-AP STA (for example, a non-AP STA that is not affiliated with a non-AP MLD, such as the STA 104-d) or an non-AP MLD STA (such as the STA 104-c affiliated with the non-AP MLD 506), and the “AP” may be a non-MLD AP (such as the AP 102-a) or an MLD AP (such as the AP 102-d affiliated with the AP MLD 504-a or the AP 102-e affiliated with the AP MLD 504-b).

To transition from a serving AP (such as the AP 102-d) to a target AP (such as the AP 102-e), the target AP may need to know various user data context parameters associated with the STA, such as a SN, a PN, a PN, and/or an a set of encryption keys for the STA. For latency-sensitive operations and applications, there may not be enough time for the serving AP to transfer the complete context to the target AP before active user data transfer can start with the target AP.

In some implementations, encryption keys can be asynchronously prefetched to the target AP. As the STA moves closer to some potential target APs, the current encryption keys in use can be prefetched to those candidate target APs, such that if the STA ends up roaming to one of those APs, both the target AP and the STA will have the correct encryption key, and can begin transmissions immediately. Asynchronously fetching encryption keys may be suitable for roaming operations (because encryption keys do not change frequently after association), but other parameters like SN, PN, and BA may change rapidly during an active data session. The target AP may need to obtain/acquire the latest values of these parameters before active user data communications with the STA can begin. In some implementations, however, this may be infeasible due to the communication latency between APs (which could be more than 20 ms). Thus, a new context acquisition scheme may be needed to enable immediate user data communications with the target AP (without having to wait for the serving AP to transfer these parameters to the target AP).

In accordance with the described techniques, the current 48-bit PN space may be divided (for example, partitioned) into equal-sized PN segments, where each PN segment is associated with a respective PN index. For example, the 8 most significant bits (MSBs) of the 48-bit PN may be used to represent the index of a given PN segment. Thus, each PN segment may have a length of 240 possible values, and the PN indices can range from 0 to 256. In the context of the signaling diagram 500, the STA may have one serving AP and zero or more candidate/target APs. The serving AP of the STA may use one of the PN segments for communications with the STA. Each candidate AP may be assigned a different PN segment that is assigned but not yet activated/used for communications with the STA.

The current index in use (index_in_use) may be equal to the index (PN_index) of the PN segment in-use currently by the serving AP and STA. Indexes assigned to other candidate/target APs may be represented as index_assigned[i]=PN index assigned to AP[i], where i is the index of APs in the candidate AP set. To initialize the PN indices, index_in_use may be set to 0, and index_assigned[k] may be set to 0+k, where k is equal to 0, 1, 2, etc. When STA roams/associates with AP[j], (where AP[j] is one of the candidate APs before roaming), the index_in_use may be set to index_assigned[j]. Accordingly, the index assigned to AP[j] becomes the index in-use (index_in_use++). For k=0 to N−1 (where N is the number of candidate APs after roaming), index_assigned[k] may be set to index_in_use+k. Alternatively, index_assigned[k] may be set to index_in_use.

The receiver (such as the AP 102-e) may instantiate a separate full 48-bit PN counter for each AP (initialized by the PN segment in-use). Anti-replay PN check may be performed using the 48-bit PN counter corresponding to the AP on which the packet was received. The PN counter may be initialized per the PN segment corresponding to index_in_use of the AP. In some implementations, the AP and the STA may initiate a rekey procedure when all PN values within a PN segment are exhausted and/or when the index_in_use reaches the total number of PN segments. When roaming, the STA may ensure that sufficient time passes, such that any UL packets 508 recently sent to the serving AP (for example, the AP 102-d) are delivered to the gateway before sending a Multi-Link (ML) Add Link Request (REQ) frame 510 to the target AP (for example, the AP 102-e), at which point the SN is reset to 0 (or a predetermined value higher than the current sequence number) for the target AP, and the STA can begin active user data exchange with the target AP immediately (using the PN segment assigned to the target AP). The STA may wait before sending the ML Add Link REQ frame 510 to avoid having an UL packet sent from the serving AP reach the gateway after the data path switches, since UL packets from the previous serving AP may trigger a data path switch back to the original path.

Examples of PN index assignments for candidate/target APs are shown in Tables 1 and 2 below. For the example shown in Table 1, AP1 (such as the AP 102-d), AP2 (such as the AP 102-c), AP3 (such as the AP 102-e), and AP4 (such as the AP 102-f) may be assigned and distributed in a single profiles. When the STA moves from AP1 towards AP2 or AP3 and roams to a new serving AP (such as AP3), the PN indices assigned to other APs may be updated/shifted accordingly. Some PN segments (such as PN segments 0, 2, and 5) may be used, while other PN segments (such as PN segments 1, 3, and 4) may be unused. For the example shown in Table 2, PN segments 0, 1, and 2 are sequentially used by target APs as the STA moves along and roams from AP to AP.

TABLE 1
Assignment of PN indices and corresponding PN segments

| Current | |
|---|---|
| Serving AP | Index_in_use and assignment |
| AP1 | Index_in_use = 0 |
| | Index_assigned[AP2] = 1 |
| | Index_assigned[AP3] = 2 |
| | Index_assigned[AP4] = 3 |
| AP3 | Index_in_use = 2 |
| | Index_assigned[AP1] = 3 |
| | Index_assigned[AP2] = 4 |
| | Index_assigned[AP4] = 5 |
| AP4 | Index_in_use = 5 |
| | Index_assigned[AP3] = 6 |
| | Index_assigned[AP5] = 7 |

TABLE 2
Assignment of PN indices and corresponding PN segments

| Current | |
|---|---|
| Serving AP | Index_in_use and assignment |
| AP1 | Index_in_use = 0 |
| | Candidate APs are AP2, AP3, and AP4 |
| AP3 | Index_in_use = 1 |
| | Candidate APs are AP1, AP2, and AP4 |
| AP4 | Index_in_use = 2 |
| | Candidate APs are AP3 and AP5 |

As the STA moves along and transitions from AP to AP, the network may recommend candidate APs to the non-AP MLD 506 (for example, via an 802.11be Link Recommendation frame), and the network may assign a different PN segment index to each candidate AP when the STA roams to a different AP. In some implementations, it may be desirable for the STA to finish sending/receiving all DL/UL packets to/from the serving AP beforehand. In particular, the STA may wait to make sure there are no more UL packets 508 sent from the serving AP to the gateway (by finishing all UL packets and refraining from sending new UL packets to the serving AP).

In some implementations, the SN used by the STA may change by a certain amount (for example, an offset or shift) for transmissions to/from the target AP. For example, if the serving AP is currently using SN 45, the target AP may start using the SN value 100. Thus, transmissions from the serving AP during the transitory (for example, roaming) period may include PNs 46, 47, 48 and so on, while transmissions from the target AP include PN values 100, 101, 102, and so on. With this scheme, the SN space for the two APs remains distinct, and any retransmissions from the serving or target AP can occur without creating issues. Furthermore, when the non-AP STA has completed the transition to the target AP, the target AP can send a BlockAckRequest (BAR) frame to advance the SN to 100, such that all frames received from the previous (serving) AP are passed to higher layers and any gaps (for example, 48 to 99) are disregarded.

Thereafter, the STA may send an ML Add Link REQ frame 510 to the target AP using PN values within the assigned PN segment for that target AP. Accordingly, the PN segment of the target AP will become the index-in-use. The STA may obtain a group temporal key (GTK), an integrity group temporal key (IGTK), and a broadcast integrity group temporal key (BIGTK) of the target AP from an ML Add Link Response (RESP) frame 512. In turn, the target AP may send a path switch frame to the gateway, and the gateway may switch the data patch of the STA to the target AP. The network may re-assign new PN segments and indices to the candidate APs and indicate these assignments to the STA after roaming is complete.

In some implementations, a serving AP (or a centralized controller) may provide security key(s) associated with a particular client/STA to neighboring APs that are affiliated with the same single mobility domain (SMD) MLD 502. Similarly, the serving AP can provide one or more of a PN index or an SN offset to each neighboring AP. In some implementations, this exchange may occur over-the-air between APs, in which case the parameters may be signaled via one or more frame(s), element(s), and field(s). The centralized controller can provision the APs with security keys, such that over-the-air transmissions are protected. Alternatively, communications between APs can occur via a secure backhaul connection. For example, the controller can handle the provisioning of encryption key(s) for each client, PN/SN index/offset assignments, etc.

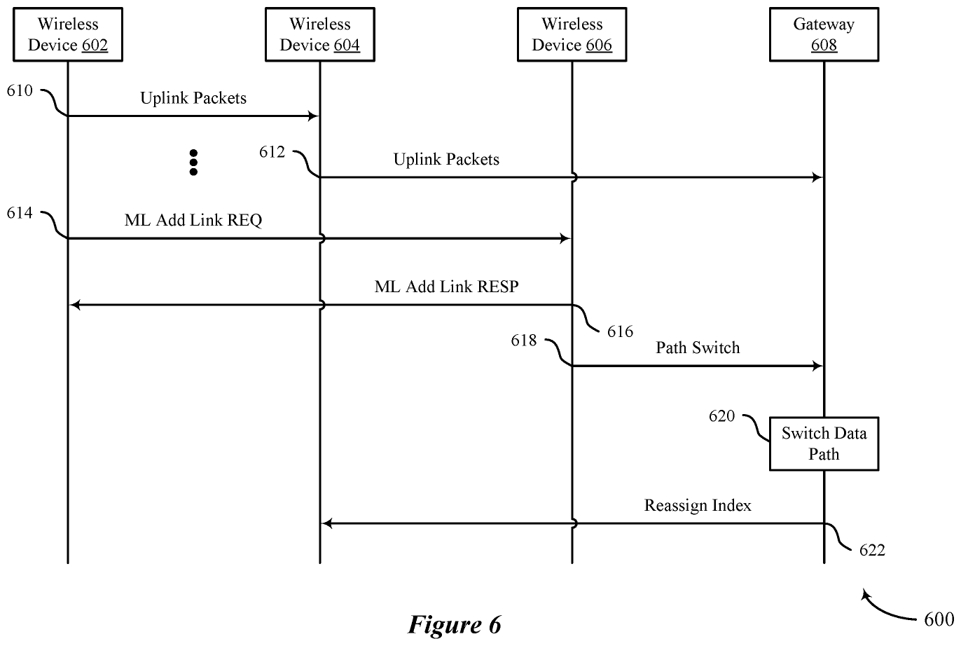

FIG. 6 shows an example of a process flow 600 that supports context acquisition for seamless roaming. The process flow 600 may implement one or more aspects of the wireless communication network 100 or the signaling diagram 500, as shown and described with reference to FIGS. 1 and 5. For example, the process flow 600 includes a wireless device 602 (such as a non-AP STA 102 or a non-AP MLD 506), a wireless device 604 (such as a first non-MLD AP 102 or AP MLD 504), and a wireless device 606 (such as a second non-MLD AP 102 or AP MLD 504), which may communicate with each other via one or more communication links 106. In some implementations, the wireless device 604 may communicate with the wireless device 606 via a gateway 608.

At 610, the wireless device 602 (for example, a first wireless device) may transmit user data (such as UL packets 508) to the wireless device 604 (for example, a second wireless device) via a first set of communication links between the wireless device 602 and the wireless device 604. The wireless device 602 may transmit the user data to the wireless device 604 using a first set of user data context parameters (such as a segment of PNs) associated with a first index assigned to the wireless device 604. In some implementations, a different set of data context parameters may be assigned to each candidate or neighboring AP of the wireless device 602.

At 612, the wireless device 604 may forward the user data from the wireless device 602 to the gateway 608, which may forward/route the user data accordingly. In some implementations, a centralized controller may communicate with the wireless device 604 and/or the wireless device 606 via the gateway 608. For example, the centralized controller may assign respective PN segments and corresponding indices to each candidate AP associated with a STA of the wireless device 602. The particular index (and corresponding segment of PNs) assigned to the wireless device 606 may be different from the index (and corresponding segment of PNs) assigned to the wireless device 604.

At 614, the wireless device 602 may decide to roam (for example, transition) from the wireless device 604 to the wireless device 606 based on, for example, a position of the wireless device 602 relative to the wireless device 604 and/or the wireless device 606, a signal strength of the wireless device 604 relative to the wireless device 606, and so on. To initiate the transfer from the wireless device 604 to the wireless device 606, the wireless device 602 may transmit one or more packets (such as a ML Add Link REQ frame 510) to the wireless device 606 via a second set of communication links between the wireless device 602 and the wireless device 606. The wireless device 602 may transmit the one or more packets using a second set of user data context parameters (such as a PN, SN, or BA) associated with an index assigned to the wireless device 606.

In some implementations, the wireless device 602 may include the second index (such as a PN index) of the wireless device 604 in a 48-bit PN field of a frame. In other implementations, the second index may be carried in a separate portion of the frame, and the 48-bit PN value may be carried in the same location. At the receiver side, during replay check, the wireless device 606 may combine both values (for example, the PN value and the PN index), where the index fields are the MSBs of the collective/combined value. Upon receiving the one or more packets that include or indicate the second set of user data context parameters, the wireless device 606 may transmit one or more messages, frames, or signals (such as a ML Add Link RESP frame 512) to the wireless device 602 at 616. The messages, frames, and/or signals from the wireless device 606 may indicate various user data context parameters for the wireless device 602 to use, such as a GTK, an IGTK, and a BIGTK, among other examples.

After exchanging data with the wireless device 602 using the second set of user data context parameters assigned to the wireless device 606, the wireless device 606 may send a path switch frame to the gateway 608 at 618, which may prompt the gateway 608 to switch a current data path for the wireless device 602 from the wireless device 604 to the wireless device 606 at 620. In some implementations, the wireless device 602 may wait until a threshold amount of time has passed before initiating the ML Add Link REQ/RESP frame exchange with the wireless device 606, such that uplink packets forwarded from the wireless device 604 to the gateway 608 (at 612) do not cause the gateway to switch the data path back to the wireless device 604.

At 622, the gateway 608 may re-assign indices (and corresponding user data context parameters) to the wireless device 604 after switching the current data path of the wireless device 602 from the wireless device 604 to the wireless device 606. For example, the gateway 608 may assign new PN segments (and corresponding PN indices) to the wireless device 604 and other target/candidate APs for the STA of the wireless device 602. The new/updated index assignments may, in some implementations, be conveyed to the wireless device 602 via the wireless device 606 currently serving the wireless device 602.

In some implementations, the process flow 600 may include partitioning a 48-bit PN space into segments that are indexed by a PN segment index. An existing 48-bit PN space can be used to represent the PN segment index and the PN segments. Alternatively, the 48-bit PN space can be expanded to a larger PN space. In some implementations, the network may pre-assign a PN segment to each candidate AP (as shown in Table 1). When roaming, the network may notify the target AP of the highest PN segment index currently in use, so the target AP can use the next index (as shown in Table 2).

In some implementations, the PN/SN direction may be direction-specific. For example, the PN or SN values used by one or more of the wireless devices depicted in the example of FIG. 6 may be different for UL and DL frames. Also, the SN space may be TID-specific, while the PN space may be common across all TIDs.

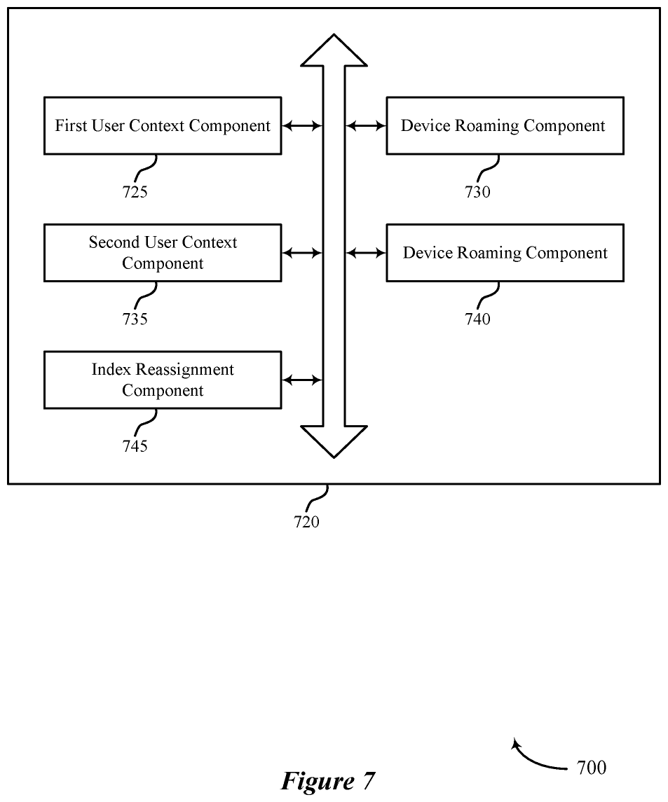

FIG. 7 shows a block diagram 700 of a first wireless device 720 that supports context acquisition for seamless roaming. The first wireless device 720 may be an example of aspects of a first wireless device as described with reference to FIGS. 2-6. The first wireless device 720, or various components thereof, may be an example of means for performing various aspects of context acquisition for seamless roaming as described herein. For example, the first wireless device 720 may include a first user context component 725, a device roaming component 730, a second user context component 735, a device roaming component 740, an index reassignment component 745, or any combination thereof. Each of these components, or components or subcomponents thereof (for example, one or more processors, one or more memories, processor circuitry, memory circuitry), may communicate, directly or indirectly, with one another (for example, via one or more buses).

The first wireless device 720 may support wireless communication in accordance with examples as disclosed herein. The first user context component 725 is configurable or configured to communicate with a second wireless device via a first set of communication links between the first wireless device and the second wireless device using a first subset of multiple user data context parameters corresponding to a first index assigned to the second wireless device. The device roaming component 730 is configurable or configured to roam from the second wireless device to a third wireless device based on a status of the first set of communication links and based on a status of a second set of communication links between the first wireless device and the third wireless device, where the roaming includes transmitting or receiving user data via the second set of communication links using a second subset of the multiple user data context parameters corresponding to a second index assigned to the third wireless device. The second user context component 735 is configurable or configured to communicate with the third wireless device via the second set of communication links based on using the second subset of the multiple user data context parameters to roam from the second wireless device to the third wireless device.

In some implementations, to support transmitting or receiving the user data, the second user context component 735 is configurable or configured to transmit or receive a packet via the second set of communication links using the second subset of the multiple user data context parameters, where the user data context parameters include at least one of an encryption key, a PN, a SN, or a BA associated with the second index assigned to the third wireless device.

In some implementations, the first user context component 725 is configurable or configured to obtain an indication of the multiple user data context parameters that are partitioned into two or more subsets associated with respective indices, each subset including multiple values associated with a respective index.

In some implementations, to support transmitting or receiving the user data, the second user context component 735 is configurable or configured to transmit or receive, via the second set of communication links, a message containing a PN field associated with the second index assigned to the third wireless device, where a first quantity of bits in the PN field indicate the second index and a second quantity of bits in the PN field indicate a PN within a PN segment associated with the second index.

In some implementations, a length of the PN field be 48 bits. In some implementations, the 8 most significant bits of the PN field indicate the second index. In some implementations, the remain 40 bits of the PN field indicate the PN within the PN segment associated with the second index.

In some implementations, to support transmitting or receiving the user data, the second user context component 735 is configurable or configured to transmit or receive, via the second set of communication links, a frame containing a PN associated with the second subset of the multiple user data context parameters and a separate field indicating the second index assigned to the third wireless device.

In some implementations, the first wireless device includes a non-AP MLD, a STA affiliated with the non-AP MLD, or a non-MLD non-AP STA. In some implementations, the second wireless device include a first non-MLD AP or a first AP MLD. In some implementations, the third wireless device include a second non-MLD AP or a second AP MLD.

In some implementations, the first AP include a serving AP of the STA. In some implementations, the second AP include a candidate or target AP to which the STA is roaming.

In some implementations, to support communicating with the second wireless device, the second user context component 735 is configurable or configured to transmit or receive one or more packets via the first set of communication links, the one or more packets including PNs associated with the first index of a PN segment currently being used for communications between the serving AP and the STA.

In some implementations, to support transmitting or receiving the user data, the second user context component 735 is configurable or configured to transmit or receive one or more packets via the second set of communication links, the one or more packets including PNs within a PN segment associated with the second index assigned to the candidate or target AP.

In some implementations, each candidate or target AP of the STA is assigned a different subset of user data context parameters from the multiple user data context parameters.

In some implementations, the first subset of the multiple user data context parameters include a segment of PNs that are usable for communications between the second wireless device and the first wireless device.

In some implementations, the second subset of the multiple user data context parameters be unused until the first wireless device roams from the second wireless device to the third wireless device.

In some implementations, to support roaming from the second wireless device to the third wireless device, the device roaming component 740 is configurable or configured to establish a connection with the third wireless device without performing a reassociation frame exchange with the third wireless device.

In some implementations, the second index be assigned to the third wireless device according to the first index assigned to the second wireless device serving the first wireless device.

In some implementations, the second user context component 735 is configurable or configured to use the second subset of the multiple user data context parameters to communicate with the third wireless device via the second set of communication links in accordance with roaming from the second wireless device to the third wireless device.

In some implementations, the index reassignment component 745 is configurable or configured to receive an indication that a third index corresponding to a third subset of the multiple user data context parameters has been reassigned to the second wireless device previously serving the first wireless device.

In some implementations, a value of the third index be a function of the second index associated with the third wireless device now serving the first wireless device.

In some implementations, to support transmitting or receiving the user data, the second user context component 735 is configurable or configured to transmit one or more packets to the third wireless device via the second set of communication links in association with determining that a threshold amount of time has elapsed with respect to a last uplink packet sent via the first set of communication links.

In some implementations, to support transmitting or receiving the user data, the second user context component 735 is configurable or configured to perform an active user data exchange with a target AP of the third wireless device after a SN for the third wireless device is set to a predetermined value that is higher than the current sequence number, where the active user data exchange is performed using a PN segment associated with the second index assigned to the third wireless device.

In some implementations, to support roaming, the device roaming component 740 is configurable or configured to transmit a first set of packets using a first set of SNs associated with the first index assigned to the second wireless device. In some implementations, to support roaming, the device roaming component 740 is configurable or configured to transmit a second set of packets using a second set of SNs associated with the second index assigned to the third wireless device, where the first set of SNs is offset from the second set of SNs.

In some implementations, to support communicating with the second wireless device, the second user context component 735 is configurable or configured to receive, via the first set of communication links, a link recommendation message indicating one or more candidate APs for the first wireless device, where each of the one or more candidate APs is assigned a different PN index for the multiple user data context parameters.

In some implementations, to support communicating with the third wireless device, the second user context component 735 is configurable or configured to transmit an ML Add Link REQ frame to the third wireless device via the second set of communication links using one or more PN values within the second subset of the multiple user data context parameters assigned to the third wireless device.

In some implementations, to support communicating with the third wireless device, the second user context component 735 is configurable or configured to receive an ML Add Link RESP frame from the third wireless device via the second set of communication links, the ML Add Link RESP frame indicating a set of encryption keys to use for communicating with a target AP of the third wireless device.

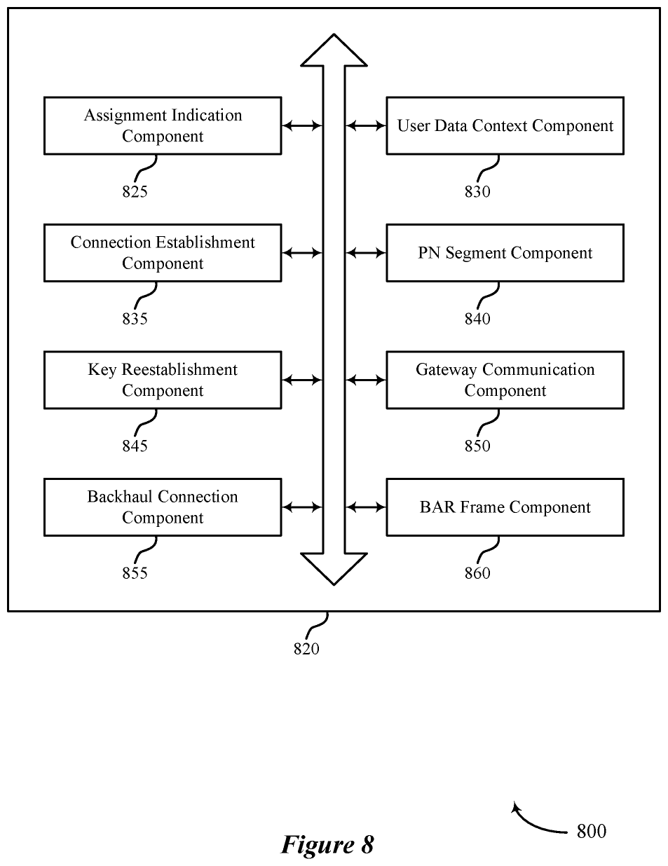

FIG. 8 shows a block diagram 800 of a third wireless device 820 that supports context acquisition for seamless roaming. The third wireless device 820 may be an example of aspects of a third wireless device as described with reference to FIGS. 2-6. The third wireless device 820, or various components thereof, may be an example of means for performing various aspects of context acquisition for seamless roaming as described herein. For example, the third wireless device 820 may include an assignment indication component 825, a user data context component 830, a connection establishment component 835, a PN segment component 840, a key reestablishment component 845, a gateway communication component 850, a backhaul connection component 855, a BAR frame component 860, or any combination thereof. Each of these components, or components or subcomponents thereof (for example, one or more processors, one or more memories), may communicate, directly or indirectly, with one another (for example, via one or more buses).

The third wireless device 820 may support wireless communications in accordance with examples as disclosed herein. The assignment indication component 825 is configurable or configured to obtain an indication of a second index assigned to the third wireless device, the second index corresponding to a second subset of multiple user data context parameters that are usable for communications with a first wireless device. The user data context component 830 is configurable or configured to receive, via a second set of communication links between the third wireless device and the first wireless device that is roaming from a second wireless device to the third wireless device, user data that indicates the second subset of the multiple user data context parameters corresponding to the second index assigned to the third wireless device, where a first subset of the multiple user data context parameters corresponds to a first index assigned to the second wireless device from which the first wireless device is roaming. The connection establishment component 835 is configurable or configured to communicate with the first wireless device via the second set of communication links using the second subset of the multiple user data context parameters corresponding to the second index assigned to the third wireless device based on receiving the user data from the first wireless device roaming from the second wireless device to the third wireless device.

In some implementations, the PN segment component 840 is configurable or configured to instantiate a respective 48-bit PN counter for each AP associated with the first wireless device, where the respective 48-bit PN counter is initialized according to a first PN segment currently being used to communicate with the first wireless device.

In some implementations, the PN segment component 840 is configurable or configured to perform an anti-replay PN check using the respective 48-bit PN counter associated with an AP of the third wireless device that received the user data from the first wireless device.

In some implementations, to support receiving the user data, the user data context component 830 is configurable or configured to receive, via the second set of communication links, a frame containing a PN associated with the second subset of the multiple user data context parameters and a separate field indicating the second index assigned to the third wireless device. In some implementations, to support receiving the user data, the PN segment component 840 is configurable or configured to perform a replay check by combining the PN with the second index.

In some implementations, the key reestablishment component 845 is configurable or configured to perform a key reestablishment procedure between the first wireless device and the third wireless device based on a quantity of available PN values in the second subset of the multiple user data context parameters, a quantity of PN segments or subsets remaining in the multiple user data context parameters, or both.

In some implementations, the gateway communication component 850 is configurable or configured to transmit or receive one or more packets via a gateway between the second wireless device and the third wireless device prior to receiving the user data from the first wireless device via the second set of communication links between the first wireless device and the third wireless device.

In some implementations, the gateway communication component 850 is configurable or configured to transmit, via a gateway, a path switch frame associated with switching a data path of the first wireless device from the second wireless device to the third wireless device.

In some implementations, the user data context component 830 is configurable or configured to receive, from a centralized controller or a serving AP of the first wireless device, one or more frames, elements, or fields indicating at least one of a security key, a PN index, or a SN offset for the first wireless device, where communicating with the first wireless device via the second set of communication links is based on the one or more frames, elements, or fields.

In some implementations, the security key for the first wireless device be securely provisioned by the centralized controller. In some implementations, the user data context component 830 is configurable or configured to transmit, to a set of neighboring APs affiliated with an SMD multi-link device, one or more frames, elements, or fields indicating at least one of a security key, a PN index, or a SN offset for the first wireless device.

In some implementations, the backhaul connection component 855 is configurable or configured to receive, via a secure backhaul connection between the third wireless device and a centralized controller, a message indicating at least one security key, a PN index, or an SN offset for the first wireless device, where the at least one security key is provisioned by the centralized controller.

In some implementations, the BAR frame component 860 is configurable or configured to transmit a BAR frame to the first wireless device via the second set of communication links after the first wireless device successfully transitions from the second wireless device to the third wireless device.

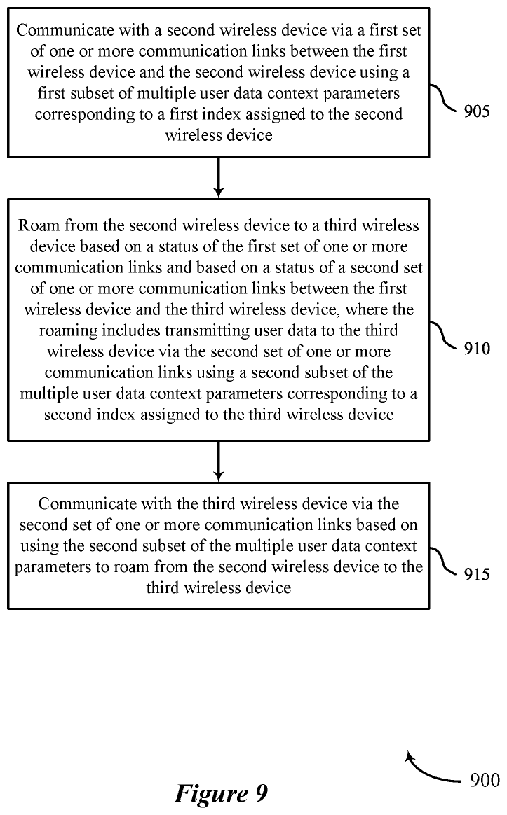

FIG. 9 shows a flowchart illustrating a method 900 that supports context acquisition for seamless roaming. The operations of the method 900 may be implemented by a first wireless device or components thereof, as described herein. For example, the operations of the method 900 may be performed by the wireless device 602 shown and described with reference to FIG. 6. In some implementations, the first wireless device may execute a set of instructions to control the functional elements of the first wireless device to perform the described functions. Additionally, or alternatively, the first wireless device may perform aspects of the described functions using special-purpose hardware.

At 905, the first wireless device may communicate with a second wireless device (such as the wireless device 604 shown and described with reference to FIG. 6) via a first set of communication links between the first wireless device and the second wireless device using a first subset of multiple user data context parameters (such as a segment of PN values) corresponding to a first index assigned to the second wireless device. In some implementations, aspects of the operations of 905 may be performed by a first user context component 725, as described with reference to FIG. 7.

At 910, the first wireless device may roam from the second wireless device to a third wireless device (such as the wireless device 606 shown and described with reference to FIG. 6) based on a status of the first set of communication links and based on a status of a second set of communication links between the first wireless device and the third wireless device, where the roaming includes transmitting user data (such as an ML Add Link REQ frame 510, as shown and described with reference to FIG. 5) to the third wireless device via the second set of communication links using a second subset of the multiple user data context parameters corresponding to a second index assigned to the third wireless device. In some implementations, aspects of the operations of 910 may be performed by a device roaming component 730, as described with reference to FIG. 7.

At 915, the first wireless device may communicate with the third wireless device via the second set of communication links (such as the communication links 106 shown and described with reference to FIG. 1) based on using the second subset of the multiple user data context parameters to roam from the second wireless device to the third wireless device. In some implementations, aspects of the operations of 915 may be performed by a second user context component 735, as described with reference to FIG. 7.

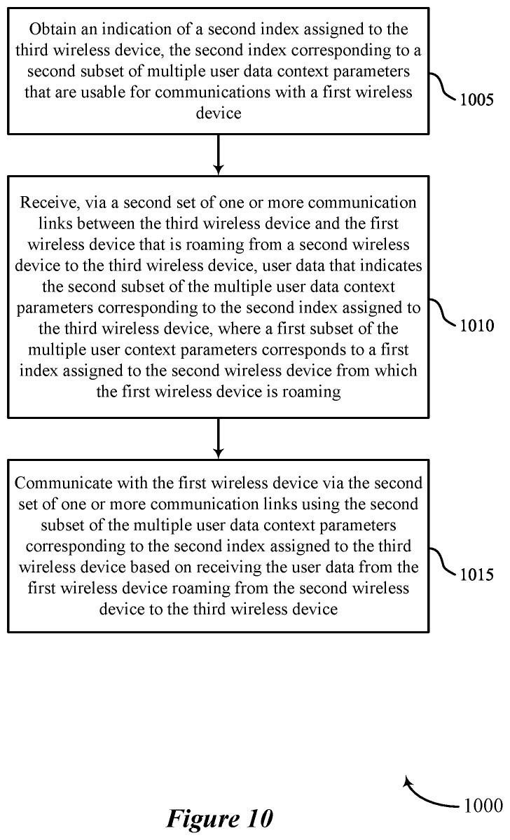

FIG. 10 shows a flowchart illustrating a method 1000 that supports context acquisition for seamless roaming. The operations of the method 1000 may be implemented by a third wireless device or components thereof, as described herein. For example, the operations of the method 1000 may be performed by the wireless device 606, as shown and described with reference to FIGS. 2-6 and 8. In some implementations, the third wireless device may execute a set of instructions to control the functional elements of the third wireless device to perform the described functions. Additionally, or alternatively, the third wireless device may perform aspects of the described functions using special-purpose hardware.

At 1005, the third wireless device may obtain an indication of a second index assigned to the third wireless device, the second index corresponding to a second subset of multiple user data context parameters (such as a segment of PN values) that are usable for communications with a first wireless device (such as the non-AP MLD 506 shown and described with reference to FIG. 5). In some implementations, aspects of the operations of 1005 may be performed by an assignment indication component 825, as described with reference to FIG. 8.

At 1010, the third wireless device may receive, via a second set of communication links between the third wireless device and the first wireless device that is roaming from a second wireless device (such as the wireless device 604 shown and described with reference to FIG. 6) to the third wireless device, user data (such as the ML Add Link REQ frame 510 shown and described with reference to FIG. 5) that indicates the second subset of the multiple user data context parameters corresponding to the second index assigned to the third wireless device, where a first subset of the multiple user data context parameters corresponds to a first index assigned to the second wireless device from which the first wireless device is roaming. In some implementations, aspects of the operations of 1010 may be performed by a user data context component 830, as described with reference to FIG. 8.

At 1015, the third wireless device may communicate with the first wireless device via the second set of communication links (such as the communication links 106 shown and described with reference to FIG. 1) using the second subset of the multiple user data context parameters corresponding to the second index assigned to the third wireless device based on receiving the user data from the first wireless device roaming from the second wireless device to the third wireless device. In some implementations, aspects of the operations of 1015 may be performed by a connection establishment component 835, as described with reference to FIG. 8.

The following provides an overview of clauses of the present disclosure:

Clause 1: A first wireless device, including: a processing system that includes processor circuitry and memory circuitry that stores code, the processing system configured to cause the first wireless device to: communicate with a second wireless device via a first set of communication links between the first wireless device and the second wireless device using a first subset of multiple user data context parameters corresponding to a first index assigned to the second wireless device; roam from the second wireless device to a third wireless device based on a status of the first set of one or more communication links and based on a status of a second set of one or more communication links between the first wireless device and the third wireless device, where the roaming includes transmitting user data to the third wireless device via the second set of one or more communication links using a second subset of the multiple user data context parameters corresponding to a second index assigned to the third wireless device; and communicate with the third wireless device via the second set of one or more communication links based on using the second subset of the multiple user data context parameters to roam from the second wireless device to the third wireless device.

Clause 2: The first wireless device of clause 1, where to transmit or receive the user data, the processing system is configured to cause the first wireless device to: transmit or receive a packet via the second set of one or more communication links using the second subset of the multiple user data context parameters, where the user data context parameters include at least one of an encryption key, a PN, a SN, or a BA associated with the second index assigned to the third wireless device.

Clause 3: The first wireless device of any of clauses 1 through 2, where the processing system is further configured to cause the first wireless device to: obtain an indication of the multiple user data context parameters that are partitioned into two or more subsets associated with respective indices, each subset including multiple values associated with a respective index.

Clause 4: The first wireless device of any of clauses 1 through 3, where to transmit or receive the user data, the processing system is configured to cause the first wireless device to: transmit or receive, via the second set of one or more communication links, a message containing a PN field associated with the second index assigned to the third wireless device, where a first quantity of bits in the PN field indicate the second index and a second quantity of bits in the PN field indicate a PN within a PN segment associated with the second index.

Clause 5: The first wireless device of clause 4, where: a length of the PN field is 48 bits; the 8 most significant bits of the PN field indicate the second index; and the remaining 40 bits of the PN field indicate the PN within the PN segment associated with the second index.

Clause 6: The first wireless device of any of clauses 1 through 5, where to transmit or receive the user data, the processing system is configured to cause the first wireless device to: transmit or receive, via the second set of one or more communication links, a frame containing a PN associated with the second subset of the multiple user data context parameters and a separate field indicating the second index assigned to the third wireless device.

Clause 7: The first wireless device of any of clauses 1 through 6, where the first wireless device includes a non-AP MLD, a STA affiliated with the non-AP MLD, or a non-MLD non-AP STA; the second wireless device includes a first non-MLD AP or a first AP MLD; and the third wireless device includes a second non-MLD AP or a second AP MLD.

Clause 8: The first wireless device of clause 7, where the first AP includes a serving AP of the STA; and the second AP includes a candidate or target AP to which the STA is roaming.

Clause 9: The first wireless device of clause 8, where to communicate with the second wireless device, the processing system is configured to cause the first wireless device to: transmit or receive one or more packets via the first set of one or more communication links, the one or more packets including PNs associated with the first index of a PN segment currently being used for communications between the serving AP and the STA.

Clause 10: The first wireless device of any of clauses 8 through 9, where to transmit or receive the user data, the processing system is configured to cause the first wireless device to: transmit or receive one or more packets via the second set of one or more communication links, the one or more packets including PNs within a PN segment associated with the second index assigned to the candidate or target AP.

Clause 11: The first wireless device of any of clauses 8 through 10, where each candidate or target AP of the STA is assigned a different subset of user data context parameters from the multiple user data context parameters.

Clause 12: The first wireless device of any of clauses 1 through 11, where the first subset of the multiple user data context parameters includes a segment of PNs that are usable for communications between the second wireless device and the first wireless device.

Clause 13: The first wireless device of any of clauses 1 through 12, where the second subset of the multiple user data context parameters are unused until the first wireless device roams from the second wireless device to the third wireless device.

Clause 14: The first wireless device of any of clauses 1 through 13, where to roam from the second wireless device to the third wireless device, the processing system is configured to cause the first wireless device to: establish a connection with the third wireless device without performing a reassociation frame exchange with the third wireless device.

Clause 15: The first wireless device of any of clauses 1 through 14, where the second index is assigned to the third wireless device according to the first index assigned to the second wireless device serving the first wireless device.

Clause 16: The first wireless device of any of clauses 1 through 15, where the processing system is further configured to cause the first wireless device to: used the second subset of the multiple user data context parameters to communicate with the third wireless device via the second set of one or more communication links in accordance with roaming from the second wireless device to the third wireless device.

Clause 17: The first wireless device of any of clauses 1 through 16, where the processing system is further configured to cause the first wireless device to: receive an indication that a third index corresponding to a third subset of the multiple user data context parameters has been reassigned to the second wireless device previously serving the first wireless device.

Clause 18: The first wireless device of clause 17, where a value of the third index is a function of the second index associated with the third wireless device now serving the first wireless device.

Clause 19: The first wireless device of any of clauses 1 through 18, where to transmit or receive the user data, the processing system is configured to cause the first wireless device to: transmit one or more packets to the third wireless device via the second set of one or more communication links in association with determining that a threshold amount of time has elapsed with respect to a last uplink packet sent via the first set of one or more communication links.

Clause 20: The first wireless device of any of clauses 1 through 19, where to transmit or receive the user data, the processing system is configured to cause the first wireless device to: perform an active user data exchange with a target AP of the third wireless device after a SN for the third wireless device is set to a predetermined value that is higher than a current SN, where the active user data exchange is performed using a PN segment associated with the second index assigned to the third wireless device.

Clause 21: The first wireless device of any of clauses 1 through 20, where to roam, the processing system is configured to cause the first wireless device to: transmit a first set of packets using a first set of SNs associated with the first index assigned to the second wireless device; and transmit a second set of packets using a second set of SNs associated with the second index assigned to the third wireless device, where the first set of SNs is offset from the second set of SNs.

Clause 22: The first wireless device of any of clauses 1 through 21, where to communicate with the second wireless device, the processing system is configured to cause the first wireless device to: receive, via the first set of one or more communication links, a link recommendation message indicating one or more candidate APs for the first wireless device, where each of the one or more candidate APs is assigned a different PN index for the multiple user data context parameters.

Clause 23: The first wireless device of any of clauses 1 through 22, where to communicate with the third wireless device, the processing system is configured to cause the first wireless device to: transmit an ML Add Link request to the third wireless device via the second set of one or more communication links using one or more PN values within the second subset of the multiple user data context parameters assigned to the third wireless device.

Clause 24: The first wireless device of any of clauses 1 through 23, where to communicate with the third wireless device, the processing system is configured to cause the first wireless device to: receive an ML Add Link response from the third wireless device via the second set of one or more communication links, the ML Add Link response indicating a set of encryption keys to use for communicating with a target AP of the third wireless device.

Clause 25: A third wireless device, including: a processing system that includes processor circuitry and memory circuitry that stores code, the processing system configured to cause the third wireless device to: obtain an indication of a second index assigned to the third wireless device, the second index corresponding to a second subset of multiple user data context parameters that are usable for communications with a first wireless device; receive, via a second set of one or more communication links between the third wireless device and the first wireless device that is roaming from a second wireless device to the third wireless device, user data that indicates the second subset of the multiple user data context parameters corresponding to the second index assigned to the third wireless device, where a first subset of the multiple the user data context parameters corresponds to a first index assigned to the second wireless device from which the first wireless device is roaming; and communicate with the first wireless device via the second set of one or more communication links using the second subset of the multiple user data context parameters corresponding to the second index assigned to the third wireless device based on receiving the user data from the first wireless device roaming from the second wireless device to the third wireless device.

Clause 26: The third wireless device of clause 25, where the processing system is further configured to cause the third wireless device to: instantiate a respective 48-bit PN counter for each AP associated with the first wireless device, where the respective 48-bit PN counter is initialized according to a first PN segment currently being used to communicate with the first wireless device.

Clause 27: The third wireless device of clause 26, where the processing system is further configured to cause the third wireless device to: perform an anti-replay PN check using the respective 48-bit PN counter associated with an AP of the third wireless device that received the user data from the first wireless device.

Clause 28: The third wireless device of any of clauses 25 through 27, where to receive the user data, the processing system is configured to cause the third wireless device to: receive, via the second set of one or more communication links, a frame containing a PN associated with the second subset of the multiple user data context parameters and a separate field indicating the second index assigned to the third wireless device; and perform a replay check by combining the PN with the second index.

Clause 29: The third wireless device of any of clauses 25 through 28, where the processing system is further configured to cause the third wireless device to: perform a key reestablishment procedure between the first wireless device and the third wireless device based on a quantity of available PN values in the second subset of the multiple user data context parameters, a quantity of PN segments or subsets remaining in the multiple user data context parameters, or both.

Clause 30: The third wireless device of any of clauses 25 through 29, where the processing system is further configured to cause the third wireless device to: transmit or receive one or more packets via a gateway between the second wireless device and the third wireless device prior to receiving the user data from the first wireless device via the second set of one or more communication links between the first wireless device and the third wireless device.

Clause 31: The third wireless device of any of clauses 25 through 30, where the processing system is further configured to cause the third wireless device to: transmit, via a gateway, a path switch frame associated with switching a data path of the first wireless device from the second wireless device to the third wireless device.

Clause 32: The third wireless device of any of clauses 25 through 31, where the processing system is further configured to cause the third wireless device to: receive, from a centralized controller or a serving AP of the first wireless device, one or more frames, elements, or fields indicating at least one of a security key, a PN index, or a SN offset for the first wireless device, where communicating with the first wireless device via the second set of one or more communication links is based on the one or more frames, elements, or fields.

Clause 33: The third wireless device of clause 32, where the security key for the first wireless device is securely provisioned by the centralized controller.

Clause 34: The third wireless device of any of clauses 25 through 33, where the processing system is further configured to cause the third wireless device to: transmit, to a set of neighboring APs affiliated with an SMD MLD, one or more frames, elements, or fields indicating at least one of a security key, a PN index, or a SN offset for the first wireless device.

Clause 35: The third wireless device of any of clauses 25 through 34, where the processing system is further configured to cause the third wireless device to: receive, via a secure backhaul connection between the third wireless device and a centralized controller, a message indicating at least one security key, a PN index, or a SN offset for the first wireless device, where the at least one security key is provisioned by the centralized controller.

Clause 36: The third wireless device of any of clauses 25 through 35, where the processing system is further configured to cause the third wireless device to: transmit a BAR frame to the first wireless device via the second set of one or more communication links after the first wireless device successfully transitions from the second wireless device to the third wireless device.

Clause 37: A method by a first wireless device, including: a processing system that includes processor circuitry and memory circuitry that stores code, the processing system configured to cause the first wireless device to: communicating with a second wireless device via a first set of communication links between the first wireless device and the second wireless device using a first subset of multiple user data context parameters corresponding to a first index assigned to the second wireless device; roaming from the second wireless device to a third wireless device based on a status of the first set of one or more communication links and based on a status of a second set of one or more communication links between the first wireless device and the third wireless device, where the roaming includes transmitting user data to the third wireless device via the second set of one or more communication links using a second subset of the multiple user data context parameters corresponding to a second index assigned to the third wireless device; and communicating with the third wireless device via the second set of one or more communication links based on using the second subset of the multiple user data context parameters to roam from the second wireless device to the third wireless device.

Clause 38: The method of clause 37, where transmitting or receiving the user data includes: transmitting or receiving a packet via the second set of one or more communication links using the second subset of the multiple user data context parameters, where the user data context parameters include at least one of an encryption key, a PN, a SN, or a BA associated with the second index assigned to the third wireless device.

Clause 39: The method of any of clauses 37 through 38, further including: obtaining an indication of the multiple user data context parameters that are partitioned into two or more subsets associated with respective indices, each subset including multiple values associated with a respective index.

Clause 40: The method of any of clauses 37 through 39, where transmitting or receiving the user data includes: transmitting or receiving, via the second set of one or more communication links, a message containing a PN field associated with the second index assigned to the third wireless device, where a first quantity of bits in the PN field indicate the second index and a second quantity of bits in the PN field indicate a PN within a PN segment associated with the second index.

Clause 41: The first wireless device of clause 40, where a length of the PN field is 48 bits; the 8 most significant bits of the PN field indicate the second index; and the remaining 40 bits of the PN field indicate the PN within the PN segment associated with the second index.

Clause 42: The method of any of clauses 37 through 41, where transmitting or receiving the user data includes: transmitting or receiving, via the second set of one or more communication links, a frame containing a PN associated with the second subset of the multiple user data context parameters and a separate field indicating the second index assigned to the third wireless device.

Clause 43: The method of any of clauses 37 through 42, where the first wireless device includes a non-AP MLD, a STA affiliated with the non-AP MLD, or a non-MLD non-AP STA; the second wireless device includes a first non-MLD AP or a first AP MLD; and the third wireless device includes a second non-MLD AP or a second AP MLD.

Clause 44: The method of clause 43, where the first AP includes a serving AP of the STA; and the second AP includes a candidate or target AP to which the STA is roaming.

Clause 45: The method of clause 44, where communicating with the second wireless device includes: transmitting or receiving one or more packets via the first set of one or more communication links, the one or more packets including PNs associated with the first index of a PN segment currently being used for communications between the serving AP and the STA.

Clause 46: The method of any of clauses 44 through 45, where transmitting or receiving the user data includes: transmitting or receiving one or more packets via the second set of one or more communication links, the one or more packets including PNs within a PN segment associated with the second index assigned to the candidate or target AP.

Clause 47: The method of any of clauses 44 through 46, where each candidate or target AP of the STA is assigned a different subset of user data context parameters from the multiple user data context parameters.

Clause 48: The method of any of clauses 37 through 47, where the first subset of the multiple user data context parameters includes a segment of PNs that are usable for communications between the second wireless device and the first wireless device.

Clause 49: The method of any of clauses 37 through 48, where the second subset of the multiple user data context parameters are unused until the first wireless device roams from the second wireless device to the third wireless device.

Clause 50: The method of any of clauses 37 through 49, where roaming from the second wireless device to the third wireless device includes: establishing a connection with the third wireless device without performing a reassociation frame exchange with the third wireless device.

Clause 51: The method of any of clauses 37 through 50, where the second index is assigned to the third wireless device according to the first index assigned to the second wireless device serving the first wireless device.

Clause 52: The method of any of clauses 37 through 51, further including: using the second subset of the multiple user data context parameters to communicate with the third wireless device via the second set of one or more communication links in accordance with roaming from the second wireless device to the third wireless device.

Clause 53: The method of any of clauses 37 through 52, further including: receiving an indication that a third index corresponding to a third subset of the multiple user data context parameters has been reassigned to the second wireless device previously serving the first wireless device.

Clause 54: The method of clause 53, where a value of the third index is a function of the second index associated with the third wireless device now serving the first wireless device.

Clause 55: The method of any of clauses 37 through 54, where transmitting or receiving the user data includes: transmitting one or more packets to the third wireless device via the second set of one or more communication links in association with determining that a threshold amount of time has elapsed with respect to a last uplink packet sent via the first set of one or more communication links.

Clause 56: The method of any of clauses 37 through 55, where transmitting or receiving the user data includes: performing an active user data exchange with a target AP of the third wireless device after a SN for the third wireless device is set to a predetermined value that is higher than a current SN, where the active user data exchange is performed using a PN segment associated with the second index assigned to the third wireless device.

Clause 57: The method of any of clauses 37 through 56, where the roam includes: transmitting a first set of packets using a first set of SNs associated with the first index assigned to the second wireless device; and transmitting a second set of packets using a second set of SNs associated with the second index assigned to the third wireless device, where the first set of SNs is offset from the second set of SNs.

Clause 58: The method of any of clauses 37 through 57, where communicating with the second wireless device includes: receiving, via the first set of one or more communication links, a link recommendation message indicating one or more candidate APs for the first wireless device, where each of the one or more candidate APs is assigned a different PN index for the multiple user data context parameters.

Clause 59: The method of any of clauses 37 through 58, where communicating with the third wireless device includes: transmitting an ML Add Link request to the third wireless device via the second set of one or more communication links using one or more PN values within the second subset of the multiple user data context parameters assigned to the third wireless device.

Clause 60: The method of any of clauses 37 through 59, where communicating with the third wireless device includes: receiving an ML Add Link response from the third wireless device via the second set of one or more communication links, the ML Add Link response indicating a set of encryption keys to use for communicating with a target AP of the third wireless device.

Clause 61: A method by a third wireless device, including: a processing system that includes processor circuitry and memory circuitry that stores code, the processing system configured to cause the third wireless device to: obtaining an indication of a second index assigned to the third wireless device, the second index corresponding to a second subset of multiple user data context parameters that are usable for communications with a first wireless device; receiving, via a second set of one or more communication links between the third wireless device and the first wireless device that is roaming from a second wireless device to the third wireless device, user data that indicates the second subset of the multiple user data context parameters corresponding to the second index assigned to the third wireless device, where a first subset of the multiple the user data context parameters corresponds to a first index assigned to the second wireless device from which the first wireless device is roaming; and communicating with the first wireless device via the second set of one or more communication links using the second subset of the multiple user data context parameters corresponding to the second index assigned to the third wireless device based on receiving the user data from the first wireless device roaming from the second wireless device to the third wireless device.

Clause 62: The method of clause 61, further including: instantiating a respective 48-bit PN counter for each AP associated with the first wireless device, where the respective 48-bit PN counter is initialized according to a first PN segment currently being used to communicate with the first wireless device.

Clause 63: The method of clause 62, further including: performing an anti-replay PN check using the respective 48-bit PN counter associated with an AP of the third wireless device that received the user data from the first wireless device.

Clause 64: The method of any of clauses 61 through 63, where receiving the user data includes: receiving, via the second set of one or more communication links, a frame containing a PN associated with the second subset of the multiple user data context parameters and a separate field indicating the second index assigned to the third wireless device; and performing a replay check by combining the PN with the second index.

Clause 65: The method of any of clauses 61 through 64, further including: performing a key reestablishment procedure between the first wireless device and the third wireless device based on a quantity of available PN values in the second subset of the multiple user data context parameters, a quantity of PN segments or subsets remaining in the multiple user data context parameters, or both.

Clause 66: The method of any of clauses 61 through 65, further including: transmitting or receiving one or more packets via a gateway between the second wireless device and the third wireless device prior to receiving the user data from the first wireless device via the second set of one or more communication links between the first wireless device and the third wireless device.

Clause 67: The method of any of clauses 61 through 66, further including: transmitting, via a gateway, a path switch frame associated with switching a data path of the first wireless device from the second wireless device to the third wireless device.

Clause 68: The method of any of clauses 61 through 67, further including: receiving, from a centralized controller or a serving AP of the first wireless device, one or more frames, elements, or fields indicating at least one of a security key, a PN index, or a SN offset for the first wireless device, where communicating with the first wireless device via the second set of one or more communication links is based on the one or more frames, elements, or fields.

Clause 69: The method of clause 68, where the security key for the first wireless device is securely provisioned by the centralized controller.

Clause 70: The method of any of clauses 61 through 69, further including: transmitting, to a set of neighboring APs affiliated with an SMD MLD, one or more frames, elements, or fields indicating at least one of a security key, a PN index, or a SN offset for the first wireless device.

Clause 71: The method of any of clauses 61 through 70, further including: receiving, via a secure backhaul connection between the third wireless device and a centralized controller, a message indicating at least one security key, a PN index, or a SN offset for the first wireless device, where the at least one security key is provisioned by the centralized controller.

Clause 72: The method of any of clauses 61 through 71, further including: transmitting a BAR frame to the first wireless device via the second set of one or more communication links after the first wireless device successfully transitions from the second wireless device to the third wireless device.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
communicate with a second wireless device via a first set of one or more communication links between the first wireless device and the second wireless device using a first subset of a plurality of user data context parameters corresponding to a first index assigned to the second wireless device;
roam from the second wireless device to a third wireless device based at least in part on a status of the first set of one or more communication links and based at least in part on a status of a second set of one or more communication links between the first wireless device and the third wireless device, wherein the roaming comprises transmitting user data to the third wireless device via the second set of one or more communication links using a second subset of the plurality of user data context parameters corresponding to a second index assigned to the third wireless device; and
communicate with the third wireless device via the second set of one or more communication links based at least in part on using the second subset of the plurality of user data context parameters to roam from the second wireless device to the third wireless device.

2. The first wireless device of claim 1, wherein, to transmit or receive the user data, the processing system is configured to cause the first wireless device to:
transmit or receive a packet via the second set of one or more communication links using the second subset of the plurality of user data context parameters, wherein the user data context parameters comprise at least one of an encryption key, a packet number, a sequence number, or a block acknowledgement associated with the second index assigned to the third wireless device.

3. The first wireless device of claim 1, wherein the processing system is further configured to cause the first wireless device to:
obtain an indication of the plurality of user data context parameters that are partitioned into two or more subsets associated with respective indices, each subset comprising a plurality of values associated with a respective index.

4. The first wireless device of claim 1, wherein, to transmit or receive the user data, the processing system is configured to cause the first wireless device to:
transmit or receive, via the second set of one or more communication links, a message containing a packet number field associated with the second index assigned to the third wireless device, wherein a first quantity of bits in the packet number field indicate the second index and a second quantity of bits in the packet number field indicate a packet number within a packet number segment associated with the second index.

5. The first wireless device of claim 4, wherein:
a length of the packet number field is 48 bits;
the 8 most significant bits of the packet number field indicate the second index; and
the remaining 40 bits of the packet number field indicate the packet number within the packet number segment associated with the second index.

6. The first wireless device of claim 1, wherein, to transmit or receive the user data, the processing system is configured to cause the first wireless device to:
transmit or receive, via the second set of one or more communication links, a frame containing a packet number associated with the second subset of the plurality of user data context parameters and a separate field indicating the second index assigned to the third wireless device.

7. The first wireless device of claim 1, wherein:
the first wireless device comprises a non-access point (AP) multi-link device (MLD), a station (STA) affiliated with the non-AP MLD, or a non-MLD non-AP STA;
the second wireless device comprises a first non-MLD AP or a first AP MLD; and
the third wireless device comprises a second non-MLD AP or a second AP MLD.

8. The first wireless device of claim 7, wherein:
the first AP comprises a serving AP of the STA; and
the second AP comprises a candidate or target AP to which the STA is roaming.

9. The first wireless device of claim 8, wherein, to transmit or receive the user data, the processing system is configured to cause the first wireless device to:
transmit or receive one or more packets via the second set of one or more communication links, the one or more packets comprising packet numbers within a packet number segment associated with the second index assigned to the candidate or target AP.

10. The first wireless device of claim 8, wherein each candidate or target AP of the STA is assigned a different subset of user data context parameters from the plurality of user data context parameters.

11. The first wireless device of claim 1, wherein the processing system is further configured to cause the first wireless device to:
receive an indication that a third index corresponding to a third subset of the plurality of user data context parameters has been reassigned to the second wireless device previously serving the first wireless device.

12. The first wireless device of claim 1, wherein, to transmit or receive the user data, the processing system is configured to cause the first wireless device to:
transmit one or more packets to the third wireless device via the second set of one or more communication links in association with determining that a threshold amount of time has elapsed with respect to a last uplink packet sent via the first set of one or more communication links.

13. The first wireless device of claim 1, wherein, to transmit or receive the user data, the processing system is configured to cause the first wireless device to:
perform an active user data exchange with a target access point (AP) of the third wireless device after a sequence number for the third wireless device is set to a predetermined value that is higher than a current sequence number, wherein the active user data exchange is performed using a packet number segment associated with the second index assigned to the third wireless device.

14. The first wireless device of claim 1, wherein, to the roam, the processing system is configured to cause the first wireless device to:
transmit a first set of packets using a first set of sequence numbers associated with the first index assigned to the second wireless device; and
transmit a second set of packets using a second set of sequence numbers associated with the second index assigned to the third wireless device, wherein the first set of sequence numbers is offset from the second set of sequence numbers.

15. The first wireless device of claim 1, wherein, to communicate with the second wireless device, the processing system is configured to cause the first wireless device to:
receive, via the first set of one or more communication links, a link recommendation message indicating one or more candidate access points (APs) for the first wireless device, wherein each of the one or more candidate APs is assigned a different packet number index for the plurality of user data context parameters.

16. The first wireless device of claim 1, wherein, to communicate with the third wireless device, the processing system is configured to cause the first wireless device to:
transmit a Multi-Link Add Link request to the third wireless device via the second set of one or more communication links using one or more packet number values within the second subset of the plurality of user data context parameters assigned to the third wireless device.

17. The first wireless device of claim 1, wherein, to communicate with the third wireless device, the processing system is configured to cause the first wireless device to:
receive a Multi-Link Add Link response from the third wireless device via the second set of one or more communication links, the Multi-Link Add Link response indicating a set of encryption keys to use for communicating with a target access point (AP) of the third wireless device.

18. A third wireless device, comprising:
a processing system that includes processor circuitry and memory circuitry that stores code, the processing system configured to cause the third wireless device to:
obtain an indication of a second index assigned to the third wireless device, the second index corresponding to a second subset of a plurality of user data context parameters that are usable for communications with a first wireless device;
receive, via a second set of one or more communication links between the third wireless device and the first wireless device that is roaming from a second wireless device to the third wireless device, user data that indicates the second subset of the plurality of user data context parameters corresponding to the second index assigned to the third wireless device, wherein a first subset of the plurality of the user data context parameters corresponds to a first index assigned to the second wireless device from which the first wireless device is roaming; and
communicate with the first wireless device via the second set of one or more communication links using the second subset of the plurality of user data context parameters corresponding to the second index assigned to the third wireless device based at least in part on receiving the user data from the first wireless device roaming from the second wireless device to the third wireless device.

19. The third wireless device of claim 18, wherein the processing system is further configured to cause the third wireless device to:
instantiate a respective 48-bit packet number counter for each access point (AP) associated with the first wireless device, wherein the respective 48-bit packet number counter is initialized according to a first packet number segment currently being used to communicate with the first wireless device.

20. The third wireless device of claim 19, wherein the processing system is further configured to cause the third wireless device to:
perform an anti-replay packet number check using the respective 48-bit packet number counter associated with an AP of the third wireless device that received the user data from the first wireless device.

21. The third wireless device of claim 18, wherein, to receive the user data, the processing system is configured to cause the third wireless device to:
receive, via the second set of one or more communication links, a frame containing a packet number associated with the second subset of the plurality of user data context parameters and a separate field indicating the second index assigned to the third wireless device; and
perform a replay check by combining the packet number with the second index.

22. The third wireless device of claim 18, wherein the processing system is further configured to cause the third wireless device to:
perform a key reestablishment procedure between the first wireless device and the third wireless device based at least in part on a quantity of available packet number values in the second subset of the plurality of user data context parameters, a quantity of packet number segments or subsets remaining in the plurality of user data context parameters, or both.

23. The third wireless device of claim 18, wherein the processing system is further configured to cause the third wireless device to:
transmit or receive one or more packets via a gateway between the second wireless device and the third wireless device prior to receiving the user data from the first wireless device via the second set of one or more communication links between the first wireless device and the third wireless device.

24. The third wireless device of claim 18, wherein the processing system is further configured to cause the third wireless device to:
transmit, via a gateway, a path switch frame associated with switching a data path of the first wireless device from the second wireless device to the third wireless device.

25. The third wireless device of claim 18, wherein the processing system is further configured to cause the third wireless device to:
receive, from a centralized controller or a serving access point (AP) of the first wireless device, one or more frames, elements, or fields indicating at least one of a security key, a packet number index, or a sequence number offset for the first wireless device, wherein communicating with the first wireless device via the second set of one or more communication links is based at least in part on the one or more frames, elements, or fields.

26. The third wireless device of claim 18, wherein the processing system is further configured to cause the third wireless device to:
transmit, to a set of neighboring access points (APs) affiliated with an SMD multi-link device, one or more frames, elements, or fields indicating at least one of a security key, a packet number index, or a sequence number offset for the first wireless device.

27. The third wireless device of claim 18, wherein the processing system is further configured to cause the third wireless device to:
receive, via a secure backhaul connection between the third wireless device and a centralized controller, a message indicating at least one security key, a packet number index, or a sequence number offset for the first wireless device, wherein the at least one security key is provisioned by the centralized controller.

28. The third wireless device of claim 18, wherein the processing system is further configured to cause the third wireless device to:
transmit a block acknowledgement request frame to the first wireless device via the second set of one or more communication links after the first wireless device successfully transitions from the second wireless device to the third wireless device.

29. A method for wireless communication by a first wireless device, comprising:
communicating with a second wireless device via a first set of one or more communication links between the first wireless device and the second wireless device using a first subset of a plurality of user data context parameters corresponding to a first index assigned to the second wireless device;
roaming from the second wireless device to a third wireless device based at least in part on a status of the first set of one or more communication links and based at least in part on a status of a second set of one or more communication links between the first wireless device and the third wireless device, wherein the roaming comprises transmitting user data to the third wireless device via the second set of one or more communication links using a second subset of the plurality of user data context parameters corresponding to a second index assigned to the third wireless device; and
communicating with the third wireless device via the second set of one or more communication links based at least in part on using the second subset of the plurality of user data context parameters to roam from the second wireless device to the third wireless device.

30. A method for wireless communications by a third wireless device, comprising:
obtaining an indication of a second index assigned to the third wireless device, the second index corresponding to a second subset of a plurality of user data context parameters that are usable for communications with a first wireless device;
receiving, via a second set of one or more communication links between the third wireless device and the first wireless device roaming from a second wireless device to the third wireless device, user data that indicates the second subset of the plurality of user data context parameters corresponding to the second index assigned to the third wireless device, wherein a first subset of the plurality of the user data context parameters corresponds to a first index assigned to the second wireless device from which the first wireless device is roaming; and
communicating with the first wireless device via the second set of one or more communication links using the second subset of the plurality of user data context parameters corresponding to the second index assigned to the third wireless device based at least in part on receiving the user data from the first wireless device roaming from the second wireless device to the third wireless device.
